(19) United States
(12) Patent Application Publication
(10) Pub. No.: US 2022/0395791 A1
(43) Pub. Date: Dec. 15, 2022

(54) PROTECTION DEVICE FOR AN AGITATOR SHAFT OF AN AGITATOR

(71) Applicant: BASF Coatings GmbH, Münster (DE)

(72) Inventors: Alexander Kuesener, Münster (DE); Maike Krause, Münster (DE); Robert Breinert, Münster (DE); Lars Hof, Münster (DE)

(21) Appl. No.: 17/773,393

(22) PCT Filed: Nov. 5, 2020
(86) PCT No.: PCT/EP2020/081147

§ 371 Date: Apr. 29, 2022

(30) Foreign Application Priority Data
Nov. 5, 2019 (EP) 19207110.8

(51) Int. Cl. B01F 35/60; F16P 1/02; B01F 27/21; B01F 27/80

(52) U.S. Cl. CPC B01F 35/6052; F16P 1/02; B01F 27/21; B01F 27/80

(57) ABSTRACT

Described herein is a protection device for an agitator shaft of an agitator, including an upper part, which serves for form-lock-fastening of the protection device to a part of an agitator head, which does not rotate during operation of the agitator; and a lower part, which serves for contactless covering of the agitator shaft; where the protection device includes two or more shell parts which can be form-lock-connected to each other by one or more manually releasable closures. Also described herein is a method of using the protection device for protecting operating personnel from getting into contact with a rotating agitator shaft of an agitator; and an agitator including an agitator shaft attached thereon, a part of an agitator head which does not rotate during operation of the agitator and the protection device attached thereon.

The invention relates to a protection device for an agitator shaft of an agitator, in particular of a laboratory agitator, the protection device consisting of a multi-part, preferably two-part shell surrounding the agitator shaft at least in part of its length.

Agitators are used for stirring, mixing or dissolving liquids and/or solids. Their use is widespread in industry, especially in the chemical industry they are widely used.

The agitators comprise an agitator shaft driven by a motor and generally immersed in a vessel. The agitator shaft is generally firmly connected to the agitator head. It can be exchanged via a coupling, so that different stirrers can be used according to the requirements, for example disc-shaped stirrers, rods, beaters, grids or propellers.

In the laboratory area, particularly tripod agitators are in operation for which high demands are placed on occupational safety.

Manual work in the area of an operating agitator involves the danger that hair, clothing and in particular protection clothing such as rubber gloves may be accidentally drawn in by the rotating agitator shaft during operation. However, for many activities, especially those involving aggressive substances, rubber gloves must be worn in accordance with occupational safety regulations.

In order to prevent access to rotating parts of the agitator, fixed or lockable protection devices are required by safety regulations.

In practice, such protection devices are sometimes not used or used inadequately due to their complicated and cumbersome handling.

The known protection devices are, for example, pipes, in particular telescopic pipes, which can vary in length and enclose the agitator shaft, thus preventing contact between the agitator operator or the agitator operators clothing on the one hand and the rotating agitator shaft on the other.

Other protection devices are known from DE 29518224 U1, for example, in which a flexible bellows of variable length is attached to the agitator head and encloses the agitator shaft.

The aforementioned systems are closed systems whose removal, for example for cleaning purposes, is time-consuming and in which impurities, for example in folds of the bellows or between concentric tubes of the telescopic protector remain easily undiscovered. This can lead to the carry-over of impurities between different stirring batches.

When bellows are used, container covers covering the mixing vessel are also generally used, which restrict the addition of substances during stirring and the visual control of the mixing process. Moreover, there is a risk of squashing between the individual folds, when the bellows are raised.

Also known is a protection device, which consists of replaceable half shells. For this purpose, devices (motor plate, brackets) are attached to the agitator motor on which two half shells are mounted opposite each other in such a way that they enclose the agitator shaft in its length and width in such a way that the agitator shaft can move freely and protection against access is ensured. However, the mounting parts are not easily, and particularly not manually, attachable and detachable without the use of tools such as hand workshop tools.

Therefore, the purpose of this invention is to provide a protection device for rotating shafts, in particular rotating agitator shafts, which overcomes the above drawbacks and which is easy to handle, easy to clean, quick to install and remove, inexpensive to manufacture and which provides safe protection for operators.

This problem is solved by a protection device (1) for an agitator shaft (2) of an agitator (3), comprising
a. an upper part (11), which serves for form-lock-fastening of the protection device (1) to a part of an agitator head (31) of an agitator (3) which does not rotate during operation of the agitator (3); and
b. a lower part (12), which serves for the contactless covering of the agitator shaft (2); wherein
   the protection device (1) comprises two or more shell parts (4A, 4B) which are form-lock connected to each other by one or more manually releasable closures (5) that are present at least at the upper part (11) of the protection device (1).

In the following this protection device (1) is termed “protection device according to the invention”.

It is preferred that the upper part (11) and the lower part (12) of the protection device (1) according to invention form a tube with open ends by form-lock connecting the two or more shell parts (4A, 4B), preferably two half-shell parts (4A, 4B) to each other by the one or more manually releasable closures (5). Preferably the shell parts (4A) and (4B) forming the protection device (1) are in form of half tubes, were both half tubes, when form-lock connected to each other form a tube having an upper part (11) and a lower part (12), the upper part of the tube preferably having a larger tube diameter than the lower part.

It is preferred that the protection device (1) consists of two or more shell parts (4A, 4B), each comprising an upper part and a lower part, which are form-lock-connected to each other by one or more manually releasable closures (5).

The upper part (11) of the protection device (1) has a tube diameter and cross-section, which allow this part to be tightly fitted to a part of an agitator head (31), which does not rotate during operation of the agitator (3) and thus form-lock-fastens the protection device (1) to this part of the agitator. While operating the agitator (3) the protection device (1) does not rotate.

The lower part (12), serves for a contactless, at least partial covering of the agitator shaft (2) of the agitator (3). It surrounds the agitator shaft (2), while the agitator shaft (2) is rotating. The lower part of the protection device (1) is spaced from the agitator shaft (2), thus avoiding contact to the agitator shaft (2). Therefore, the lower part (12) of the protection device (1) will have a larger inner diameter and cross-section than the diameter and cross-section of the agitator shaft (2). Preferably the inner diameter of the lower part (12) of the protection device (1) is less than 20 mm even more preferred less than 10 mm and most preferred less than 5 mm larger than the diameter of the agitator shaft (2); and the inner diameter of the lower part (12) of the protection device (1) is large enough to prevent contact or friction of the agitator shaft (2) with the inner wall of the lower part (12) of the protection device (1). This perfectly allows monitoring the surface of the composition to be mixed while operating the agitator (3).

Between the upper part (11) and the lower part (12) of the protection device (1) according to the present invention a middle part (13) can be arranged, e.g. to reduce the diameter and cross-section of the upper part (11) of the protection device (1) to the diameter and cross-section of the lower part (12) of the protection device (1).

The two or more shell parts (4A, 4B) are form-lock-connected to each other by manually releasable closures (5), which are selected from the group consisting of magnetic closures (5A) and push-button closures (5B), most preferred the closures are magnetic closures (5A). The closures (5) are present at least at the upper part (11) of the protection device (1), but preferably also present at the lower part (12) of the protection device. The positions are chosen in a manner to ensure a completely closed shell. Depending on the length and weight of the protection device further closures (5) might be present.

The term “manually releasable” as used in this context means that the closures (5) can be opened and closed by the operator of the agitator just by hand without the use of tools such as hand workshop tools like e.g. screw-wrenches and screwdrivers.

The protection device (1) according to the invention can be form-lock-fastened to a part of the agitator head (31) which does not rotate during operation of the agitator (3). The protection device (1) itself does not rotate while the agitator is operated. Preferably, this part of the agitator head (31) which does not rotate during operation of the agitator (3) is a coupling protection (31A) of the agitator.

The protection device (1) according to the invention can be made of virtually any material. From a practical point of view, it is preferred that the protection device is made from a plastic material, particularly preferred from a dimensionally stable plastic material. The choice of material generally depends on the intended use of the protection device (1). In particular, the material should be inert towards the composition to be mixed by the agitator.

Furthermore, plastic materials, such as polyamides, polyalkylene terephthalates (like PET, PBT) or polymeric alloys are available having different physical and chemical properties and thus can be selected to be inert for a large variety of mixtures. Generally, such plastic materials are easily formable by injection molding or other typical molding processes to produce shell parts (4A, 4B). It is further possible to manufacture the shell parts (4A, 4B) by 3D printing techniques or any other known processing technique for plastic materials. Another advantage of forming the shell parts from plastic material is that even small wall thicknesses can lead to highly rigid dimensionally stable shell parts (4A, 4B) which are light-weight and easily attachable to each other by simple closures (5, 5A, 5B).

If, as a closure, a push-button closure (5B) is chosen, the closure can not only be made from the same plastic material as the shell part (4A, 4B), but can also be an integral part of the shell part (4A, 4B) itself.

If, as a closure, a magnetic closure (5A) is chosen, the magnets can be embedded into the plastic material in the course of producing the shell parts (4A, 4B), thus they may be completely or partially surrounded by the plastic material. If they are completely surrounded, they may not come into contact with the composition to be mixed or e.g. with aggressive gaseous or powdery material, which might escape from the mixing vessel. However, the magnetic closures (5A) can also be attached to the shell parts (4A, 4B) by conventional means such as adhesives. Furthermore, coated magnets can be attached to the shell parts (4A, 4B), particularly, if the coating of the magnets is chosen to be inert to the compositions to be mixed. One of the magnets of the magnetic closure (5A) is located at one shell part (4A) the other one is located at the other shell part (4B) in a manner, orientation and position that they attract each other. In the push-button case (56) one part of the closure contains a hole and the second part of the closure contains the button, which can be snapped into the hole, one of both being located at one shell part (4A) the other one being located at the other shell part (4B).

The magnets are preferably made of a strong magnetic material. Most preferred are samarium-cobalt magnets or neodymium magnets, the latter being even more preferred.

In a preferred embodiment of the protection device (1) the upper edge (6) of the protection device (1) has an inward facing collar (7) which is apt to even further prevent the protection device (1) from sliding down on the surface of the part of the agitator head (31) which does not rotate during operation of the agitator (3) and which is in contact with the upper part (11) of the protection device (1) during operation. If the part of the agitator head (31) which does not rotate during operation of the agitator (3) is a coupling protection (31A) of the agitator (3), the inward facing collar (7) at the upper edge of the protection device (1) rests on the upper part of the coupling protection (31A).

The inventive protection device (1) comprising such closures (5) is easy to handle, particularly easy to be attached to the agitator and detached from the agitator. This eliminates the need for cumbersome and time-consuming attachment and detachment. Further, cleaning of the simple device is facilitated in comparison with telescopic protectors and/or bellows protectors. Because of its easy use, it also increases the operator's compliance with safety regulations. Due to the easy and inexpensive production of the protection device (1) of the present invention, laboratories can hold available a complete set of such devices with different length and diameters fitting all types and sizes of agitator shafts.

Another subject of the invention is the use of the protection device (1) for protecting operating personnel from getting into contact with a rotating agitator shaft (2) of an agitator (3).

The protection device (1) in accordance with the invention can be used for any agitators in chemical laboratories and pilot plant facilities. It is particularly suitable for agitators with connectable agitator shafts, for example agitators with quick couplings.

A further subject of the invention is an agitator (3) comprising an agitator shaft (2) attached thereon, a part of an agitator head (31) comprising a coupling protector (31A) and the protection device (1) attached thereon.

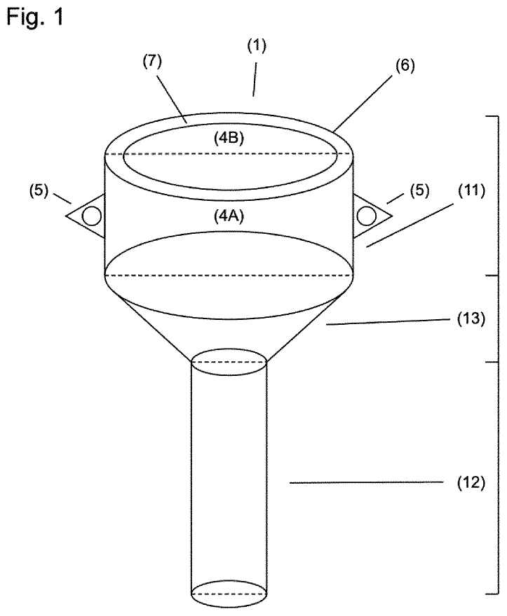

The present invention will be further explained by FIGS. 1 to 4.

FIG. 1 is a perspective view of an exemplary design of the protection device (1) according to the invention in closed form showing the upper part (11), the lower part (12) and a middle part (13) as well as the closures (5) present at the upper and lower parts of both shell parts (4A, 4B). FIG. 1 also shows the preferred inward facing collar (7) at the upper edge (6) of the protection device (1).

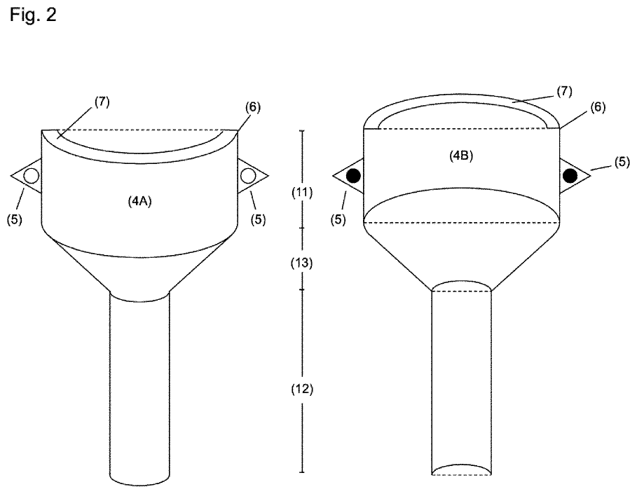

FIG. 2 is a view of two separate shell parts (4A, 4B) which are symmetrically to each other and which are apt to be attached to each other. Both shell parts (4A, 4B) have an upper part, a lower part and a middle part, which form, when connected to each other form the protection device (1) having an upper part (11), a lower part (12) and a middle part (13). Further shown are the closures (5). FIG. 2 also shows the preferred inward facing collar (7) at the upper edge (6) of each shell part (4A, 4B) of the protection device (1).

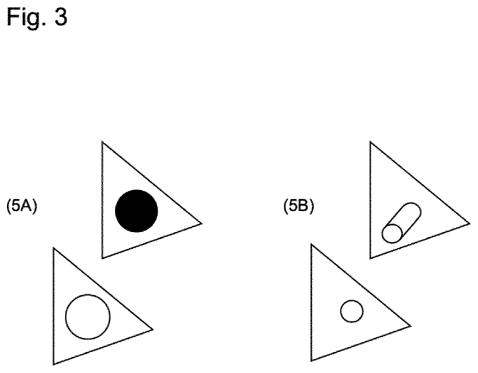

FIG. 3 is a close-up view of a magnetic closure (5A) and a push-button closure (5B). The magnets of the magnetic closure (5A) are depicted as a white and a black circle, one of both being located at shell part (4A) the other one being located at shell part (4B). In the push-button case (56) one part of the closure contains a hole and the second part of the closure contains the button, which can be snapped in the hole, one of both being located at shell part (4A) the other one being located at shell part (4B).

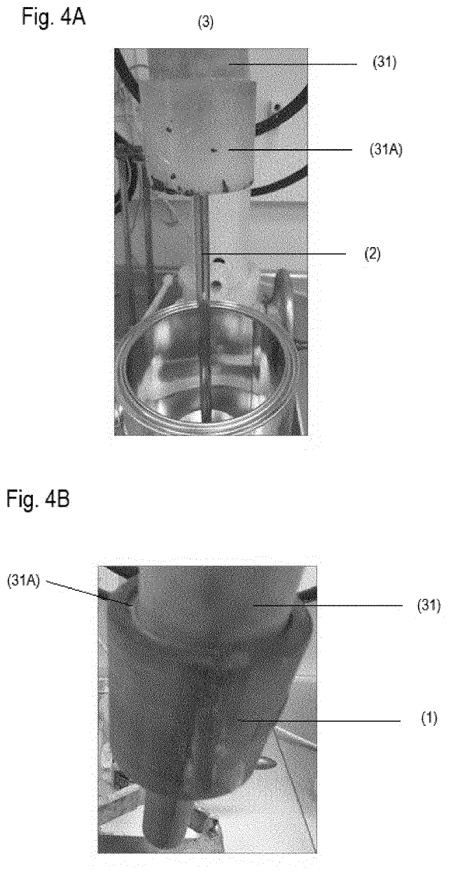

FIG. 4A shows a photograph of an agitator (3) comprising an agitator shaft (2) attached thereon, a coupling protector (31A) on an agitator head (31). FIG. 4B shows an agitator head (3) and the protection device (1) attached to the coupling protector (31A).

1. A protection device for an agitator shaft of an agitator, comprising
a. an upper part, which serves for form-lock-fastening of the protection device to a part of an agitator head of the agitator, which does not rotate during operation of the agitator; and
b. a lower part, which serves for contactless covering of the agitator shaft;
wherein the protection device comprises two or more shell parts which are form-lock-connected to each other by one or more manually releasable closures that are present at least at the upper part of the protection device.

2. The protection device according to claim 1, wherein the upper part and the lower part of the protection device form a tube with open ends by form-lock connecting the two or more shell parts to each other by the one or more manually releasable closures.

3. The protection device according to claim 1, wherein the one or more manually releasable closures are selected from the group consisting of magnetic closures and push-button closures.

4. The protection device according to claim 1, wherein the part of the agitator head which does not rotate during operation of the agitator is a coupling protection of the agitator.

5. The protection device according to claim 1, wherein the protection device is formed from a dimensionally stable plastic material.

6. The protection device according to claim 1, wherein the closure is a magnetic closure which is embedded into or attached to a dimensionally stable plastic material forming the two or more shell parts.

7. The protection device according to claim 1, wherein the protection device has an inward facing collar at an upper edge thereof.

8. The protection device according to claim 1, wherein the manually releasable closures are magnetic closures comprising magnets selected from the group consisting of samarium-cobalt magnets and neodymium magnets.

9. The protection device according to claim 1, wherein the protection device consists of two or more shell parts, each comprising an upper part and a lower part, which are form-lock-connected to each other by one or more manually releasable closures.

10. A method of using the protection device according to claim 1, the method comprising:
using the protection device to protect operating personnel from getting into contact with a rotating agitator shaft of an agitator.

11. An agitator comprising an agitator shaft attached thereon, a part of an agitator head which does not rotate during operation of the agitator and a protection device according to claim 1.

12. The agitator according to claim 11, wherein the part of the agitator head which does not rotate during operation of the agitator is a coupling protector.

13. The protection device according to claim 1, wherein the upper part and the lower part of the protection device form a tube with open ends by form-lock connecting the two or more shell parts to each other by the one or more manually releasable closures, and wherein the two or more shell parts are two half-shell parts.
